(19) United States
(12) Patent Application Publication
(10) Pub. No.: US 2026/0336512 A1
(43) Pub. Date: Oct. 29, 2026

(54) VARIABLE SPOILER LIGHTING APPARATUS OF A VEHICLE

(71) Applicants: HYUNDAI MOTOR COMPANY, Seoul (KR); KIA CORPORATION, Seoul (KR); HYUNDAI MOBIS CO., LTD., Seoul (KR)

(72) Inventors: Jae Kun Lee, Hwaseong-si (KR); Kee Hong Park, Hwaseong-si (KR); Soon Mo Lee, Yongin-si (KR); Do Hyung Kim, Yongin-si (KR); Jae Sup Byun, Yongin-si (KR)

(73) Assignees: HYUNDAI MOTOR COMPANY, Seoul (KR); KIA CORPORATION, Seoul (KR); HYUNDAI MOBIS CO., LTD., Seoul (KR)

(21) Appl. No.: 19/326,436

(22) Filed: Sep. 11, 2025

(30) Foreign Application Priority Data
Apr. 28, 2025 (KR) 10-2025-0055114

(51) Int. Cl. B60Q 1/26; B60Q 1/30; B62D 35/00; F21S 43/00

(52) U.S. Cl. CPC B60Q 1/2661; B60Q 1/2692; B60Q 1/30; B62D 35/007; F21S 43/601

(57) ABSTRACT

A variable spoiler lighting apparatus of a vehicle includes a center driver and a side driver. The center driver is provided on a central portion of a rear portion of a vehicle to be movable rearward. A spoiler, which is tiltable according to a driving mode, and a center rear lamp are mounted on the center driver. The side driver is disposed at one or both sides of the center driver and provided to be movable rearward to the rear portion of the vehicle and on which side rear lamps are mounted.

### CROSS-REFERENCE TO RELATED APPLICATION

This application claims priority to and the benefit of Korean Patent Application No. 10-2025-0055114, filed on Apr. 28, 2025, the disclosure of which is incorporated herein by reference in its entirety.

### BACKGROUND

### 1. Field of the Disclosure

The present disclosure relates to a variable spoiler lighting apparatus of a vehicle, and more specifically, to a variable spoiler lighting apparatus of a vehicle, of which aerodynamic performance is improved and which provides visual information to drivers, nearby vehicles, and pedestrians.

### 2. Discussion of Related Art

Vehicles have problems that a contact force of a rear tire is reduced during high speed driving or turning, which is disadvantageous for increased driving speed and degrades driving stability. In order to solve such problems, a spoiler is installed on the rear of a vehicle to change a flow of air surrounding a vehicle. Thus, a pressure that presses the vehicle according to the flow of the air surrounding the spoiler is generated to improve a contact force of a rear tire.

When such a spoiler is installed on the rear of a vehicle, there are problems in that there is a restriction on a degree of design freedom, it is difficult to change a design once the spoiler has been installed, and a design is degraded due to installation of the spoiler when applied to a high-end vehicle.

In addition, a rear lamp is installed on the rear of a vehicle, and generally, the rear lamp is mounted as a fixed-type rear lamp, which serves a lighting function but does not serve a function for improving aerodynamic performance.

### SUMMARY

Accordingly, it is required to differentiate an exterior design of a vehicle by developing an active spoiler in which a rear lamp installed on the rear of the vehicle can improve aerodynamic performance as well as serving a lighting function.

One embodiment of the present disclosure is directed to a variable spoiler lighting apparatus of a vehicle in which a rear lamp protruding rearward according to a mode serves a lighting function and eliminates a vortex generated at the rear of the vehicle to increase a distance to empty, i.e., improve fuel efficiency, of the vehicle.

In addition, one embodiment of the present disclosure is also directed to a variable spoiler lighting apparatus of a vehicle in which a spoiler serves an assistance function in safe driving by inducing a downward pose or stance during high speed driving or rough weather when the spoiler is tilted while protruding rearward according to a mode, improves a contact force between the vehicle and a road surface, and suppresses generation of a left-right rolling phenomenon even during high speed driving.

Objects to be achieved by the present disclosure are not limited to the above-described objects. Other objects, which are not described above, should be clearly understood by those of ordinary skill in the art through the following description.

According to an aspect of the present disclosure, a variable spoiler lighting apparatus of a vehicle is provided. The variable spoiler lighting apparatus includes a center driver and a side driver. The center driver is provided on a central portion of a rear portion of a vehicle to be movable forward and rearward. A spoiler and a center rear lamp are mounted on the center driver and the spoiler is tiltable according to a driving mode. A side driver is disposed at a first side of the center driver and is configured to be movable forward and rearward relative to the rear portion of the vehicle and on which a side rear lamp is mounted.

The center driver may include: a center housing; a center lamp housing mounted on the center housing to be movable forward and rearward and on which the center rear lamp and the spoiler are mounted; a first actuator provided on the center housing; a first driving shaft rotated according to driving of the first actuator; a first sliding part rotatably mounted on the first driving shaft and configured to move the center lamp housing; and a spoiler driver rotatably mounted on the first driving shaft and configured to tilt the spoiler according to the driving mode in a state in which the center lamp housing has moved rearward.

The first sliding part may include a first crankshaft rotatably mounted on the first driving shaft and a first rod having a rear end rotatably connected to the first crankshaft and a front end rotatably connected to the center lamp housing.

The variable spoiler lighting apparatus may further include an interlocking part configured to rotate according to the driving of the first actuator. When the center lamp housing moves rearward, the interlocking part is configured to rotate with the spoiler driver and is hooked on the first sliding part.

The interlocking part may include an interlocking cam rotatably mounted on the first driving shaft and an interlocking member inserted into a curved first guide slot formed in the center lamp housing and configured to move along with the interlocking cam being rotated.

A hooking protrusion may be formed or provided on an outer surface of the first crankshaft and a hooking end formed in the interlocking cam is hooked on the hooking protrusion when the spoiler is tilted at a maximum angle.

The spoiler driver may include a second crankshaft rotatably mounted on the first driving shaft and a second rod having a rear end rotatably connected to the second crankshaft and a front end rotatably connected to a guide part provided on the center lamp housing.

A pair of guide members disposed in parallel may be mounted on the center lamp housing, second guide slots may be formed in the guide members in a front-rear direction, and the guide part may be disposed between the guide members to be movable in the front-rear direction.

The guide part may include a first link, both sides of which are inserted into the second guide slots and to which the second rod is rotatably connected and may include a second link rotatably connected to a front end of the first link and rotatably connected to a lower surface of the spoiler.

A rear end of the first link may be rotatably connected to the second rod.

The variable spoiler lighting apparatus may further include a third link rotatably connected to one side of the guide members, may be rotatably connected to the first link, and may support the first link.

One or more first guide rails may be provided on the center housing, and the center lamp housing may be movable along the first guide rails in a front-rear direction.

The first side driver may include: a first side housing, a first rear lamp housing mounted on the first side housing to be movable rearward and on which the first side rear lamp is mounted; a second actuator provided on the side housing; a second driving shaft rotatable according to driving of the second actuator; and a second sliding part rotatably mounted on the second driving shaft and configured to move the first rear lamp housing.

The second sliding part may include a third crankshaft rotatably mounted on the second driving shaft and a third rod having a rear end rotatably connected to the third crankshaft and a front end rotatably connected to the second lamp housing.

The variable spoiler lighting apparatus may include a second side driver disposed on a second side of the center driver opposite the first side and a second side rear lamp mounted on the second side driver.

One or more second guide rails may be provided on the side housing, and the second lamp housing may be movable along the second guide rails in a front-rear direction.

According to an aspect of the present disclosure, a vehicle includes a rear portion at a rear end of the vehicle and a variable spoiler lighting apparatus that is movable between a retracted state and a rearward deployed state relative to the rear portion of the vehicle. The variable spoiler lighting apparatus includes: a center driver on a central portion of the rear portion of the vehicle and configured to be movable rearward and forward relative to the rear portion; a spoiler mounted on the center driver and tiltable according to a driving mode; a center rear lamp mounted on the center driver; a first side driver disposed at a first side of the center driver and configured to be movable forward and rearward relative to the rear portion of the vehicle; and a first side rear lamp mounted on the side driver.

### BRIEF DESCRIPTION OF THE DRAWINGS

The above and other objects, features, and advantages of the present disclosure should become more apparent to those of ordinary skill in the art by describing various embodiments thereof in detail with reference to the accompanying drawings, in which:

FIG. 1 is a view illustrating a rear portion of a vehicle in a state in which a variable spoiler lighting apparatus of a vehicle is not operated yet according to one embodiment of the present disclosure;

FIG. 2 is a view illustrating the rear portion of the vehicle in a state in which a rear lamp of the variable spoiler lighting apparatus of a vehicle has moved rearward according to one embodiment of the present disclosure;

FIG. 3 is a view illustrating the rear portion of the vehicle in a state in which a spoiler of the variable spoiler lighting apparatus of a vehicle is tilted according to one embodiment of the present disclosure;

FIG. 4 is an exploded perspective view illustrating the variable spoiler lighting apparatus of a vehicle according to one embodiment of the present disclosure;

FIG. 5 is a perspective view illustrating a center driver according to one embodiment of the present disclosure;

FIG. 6 is a view illustrating a lower surface of a side driver according to one embodiment of the present disclosure;

FIG. 7 is a view illustrating a state in which the side driver is not operated yet according to one embodiment of the present disclosure;

FIG. 8 is a view illustrating a state in which a side rear lamp has moved rearward in the side driver according to one embodiment of the present disclosure;

FIG. 9A is a view illustrating a state in which the center driver is not operated yet according to one embodiment of the present disclosure;

FIG. 9B is a view illustrating a state in which a center rear lamp has moved rearward in the center driver according to one embodiment of the present disclosure;

FIG. 9C is a view illustrating a state in which the spoiler is tilted at a first angle in the center driver according to one embodiment of the present disclosure;

FIG. 9D is a view illustrating a state in which the spoiler is tilted at a second angle in the center driver according to one embodiment of the present disclosure;

FIG. 10A is a view illustrating a first sliding part in the state in which the center driver is not operated yet according to one embodiment of the present disclosure;

FIG. 10B is a view illustrating the first sliding part in the state in which the center rear lamp has moved rearward in the center driver according to one embodiment of the present disclosure;

FIG. 10C is a view illustrating the first sliding part in the state in which the spoiler is tilted at the second angle in the center driver according to one embodiment of the present disclosure;

FIG. 11A is a view illustrating an interlocking part in the state in which the center driver is not operated yet according to one embodiment of the present disclosure;

FIG. 11B is a view illustrating the interlocking part in the state in which the center rear lamp has moved rearward in the center driver according to one embodiment of the present disclosure;

FIG. 11C is a view illustrating the interlocking part in the state in which the spoiler is tilted at the second angle in the center driver according to one embodiment of the present disclosure;

FIG. 12A is a view illustrating a spoiler driver in the state in which the center driver is not operated yet according to one embodiment of the present disclosure;

FIG. 12B is a view illustrating the spoiler driver in the state in which the center rear lamp has moved rearward in the center driver according to one embodiment of the present disclosure;

FIG. 12C is a view illustrating the spoiler driver in the state in which the spoiler is tilted at the first angle in the center driver according to one embodiment of the present disclosure; and

FIG. 12D is a view illustrating the spoiler driver in the state in which the spoiler is tilted at the second angle in the center driver according to one embodiment of the present disclosure.

### DETAILED DESCRIPTION OF EMBODIMENTS

Though embodiments of the present disclosure may be variously modified, and several embodiments are disclosed and described, specific embodiments are illustrated in the accompanying drawings and described in detail. However, this is not intended to limit the present disclosure to the specific embodiments. It should be appreciated that all changes, equivalents, and substitutes falling within the spirit and technical scope of the present disclosure are encompassed in the present disclosure. In the description of the embodiments, certain detailed descriptions of the related art have been omitted where it has been deemed that they may unnecessarily obscure the gist of the present disclosure.

Terms such as “first” and “second” may be used to describe various components, but the components are not limited by the above terms. These terms are used only to distinguish one component from another.

When a component, device, apparatus, element, or the like of the present disclosure is described as having a purpose or performing an operation, function, or the like, the component, device, apparatus, or element should be considered herein as being “configured to” meet that purpose or to perform that operation or function.

Terms used herein are only for the purpose of describing particular embodiments and are not intended to limit the present disclosure. Singular forms are intended to include the plural forms, unless the context clearly indicates otherwise. In the present specification, it should be understood that the terms “comprise,” “comprising,” “have,” “having,” “include,” and/or “including” specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected but may also mean that two or more components are indirectly connected through other components. This may also mean that components are physically connected and/or also electrically connected or may mean that the components are one component even when referred to by different names according to positions or functions thereof.

In addition, when a first component is described as being formed or disposed “on (above) or under (below)” a second component, such a description includes both a case in which the two components are formed or disposed in direct contact with each other and a case in which one or more other components are interposed between the two components. In addition, when a first component is described as being formed “on (above) or under (below)” a second component, such a description may include a case in which the first component is formed at an upper side or a lower side with respect to the second component.

Hereinafter, one embodiment of a variable spoiler lighting apparatus of a vehicle is described in detail with reference to the accompanying drawings. When an embodiment is described with reference to the accompanying drawings, components that are the same or correspond to each other are denoted by the same reference numerals, and redundant description thereof has been omitted.

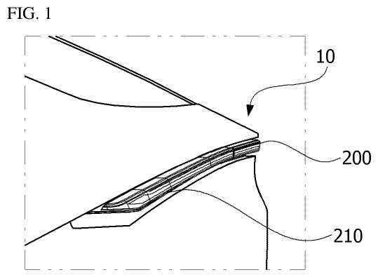

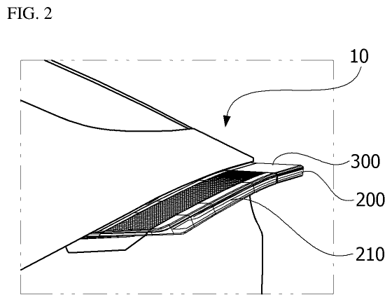

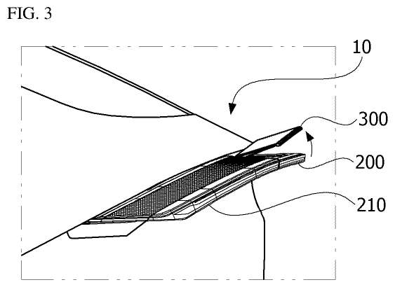

FIG. 1 is a view illustrating a rear portion of a vehicle in a state in which a variable spoiler lighting apparatus is not yet operated according to one embodiment of the present disclosure. FIG. 2 is a view illustrating the rear portion of the vehicle in a state in which a rear lamp of the variable spoiler lighting apparatus of a vehicle has moved rearward according to one embodiment of the present disclosure. FIG. 3 is a view illustrating the rear portion of the vehicle in a state in which a spoiler of the variable spoiler lighting apparatus of a vehicle is tilted according to one embodiment of the present disclosure.

Referring to FIGS. 1-4, the variable spoiler lighting apparatus of a vehicle according to one embodiment of the present disclosure may include a center driver 100, which is provided at a central portion of a rear portion 10 of the vehicle and is configured to be movable rearward. A spoiler 300, which is tiltable according to a driving mode, and a center rear lamp 200 are mounted on the center driver 100. The variable spoiler lighting apparatus may also include side drivers 400, which are respectively disposed at both sides of the center driver 100 and are provided and configured to be movable rearward to the rear portion 10 of the vehicle. Side rear lamps 210 are mounted on the side drivers 400. The below description may refer to one or both of the side drivers 400 and their related components and the description is applicable to both side drivers when only one is referred to in the description.

FIG. 1 shows a first mode in which the variable spoiler lighting apparatus is closed or retracted, before the variable spoiler lighting apparatus operates, in the rear portion 10 of the vehicle. In the first mode, the center rear lamp 200, the side rear lamps 210, and the spoiler 300 are all inserted or retracted into the rear portion 10, the center rear lamp 200 and the side rear lamps 210 are exposed to the outside, and the spoiler 300 is not exposed to the outside because it is folded without being tilted upward.

FIG. 2 shows a second mode, which is in a state in which the variable spoiler lighting apparatus is operated such that the center rear lamp 200, the side rear lamps 210, and the spoiler 300 have moved rearward in and protrude relative to the rear portion 10 of the vehicle. In the second mode, the center rear lamp 200 and the side rear lamps 210 may move rearward, and the spoiler 300 may move along with the center rear lamp 200 and the side rear lamps 210 and may be exposed to the outside. In this case, the rear lamps 200 and 210 protruding rearward according to the mode may serve a lighting function and eliminate a vortex generated at the rear of the vehicle to increase a distance to empty, i.e., the fuel efficiency, of the vehicle.

FIG. 3 shows a third mode in which the spoiler 300 is tilted upward from the second mode. In a process of switching to the third mode from the second mode, the center rear lamp 200 and the side rear lamps 210 do not move, and only the spoiler 300 may be tilted upward at a predetermined angle. The spoiler 300 may be tilted at a tilting angle not in a single step but in a plurality of steps. When the spoiler 300 is tilted as described above, the spoiler 300 serves an assistance function in safe driving by inducing a downward pose or stance during high speed driving and rough weather. In other words, even during high speed driving, a contact force between the vehicle, i.e., the tires, and a road surface can be improved, and a left-right rolling phenomenon can be suppressed.

In the present embodiment, the center rear lamp 200 and the spoiler 300 are mounted on the center driver 100 and the side rear lamps 210 are mounted on the side drivers 400. Accordingly, the center driver 100 and the side drivers 400 may move all of the center rear lamp 200 and the side rear lamps 210 rearward, and the spoiler 300 may be tilted by the center driver 100.

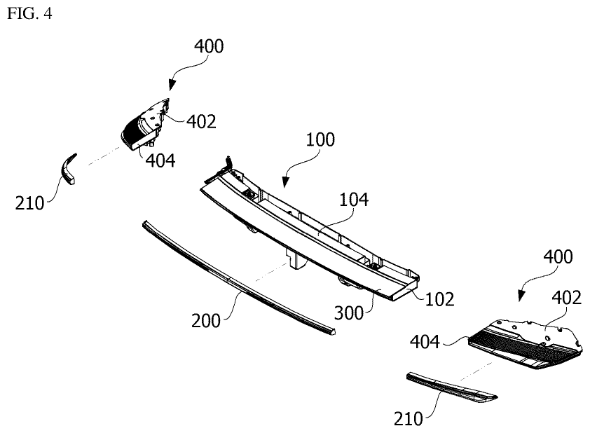

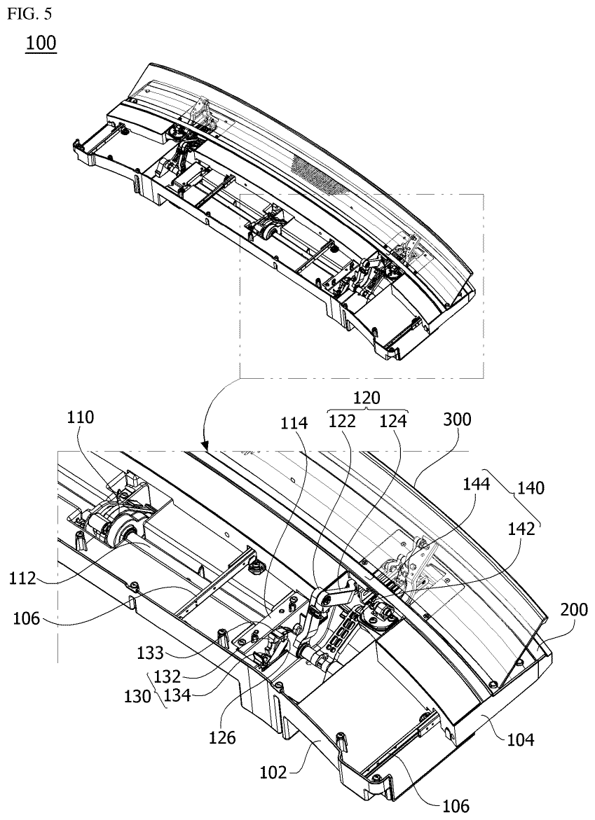

FIG. 4 is an exploded perspective view illustrating the variable spoiler lighting apparatus of a vehicle according to one embodiment of the present disclosure. FIG. 5 is a perspective view illustrating the center driver according to one embodiment of the present disclosure.

Referring to FIGS. 4 and 5, the center driver 100 may include: a center housing 102; a center lamp housing 104, which is mounted on the center housing 102 to be movable rearward and on which the center rear lamp 200 and the spoiler 300 are mounted; a first actuator 110 provided on the center housing 102; a first driving shaft 112, which is rotated according to driving of the first actuator 110; a first sliding part 120, which is rotatably mounted on the first driving shaft 112 and moves the center lamp housing 104; and a spoiler driver 140, which is rotatably mounted on the first driving shaft 112 and tilts the spoiler 300 according to a driving mode in a state in which the center lamp housing 104 has moved rearward.

The center housing 102 may have substantially a plate shape extending in a left-right direction relative to the vehicle as a reference. The center lamp housing 104 is mounted at an upper side of the center housing 102 to be movable in a front-rear direction relative to the vehicle as a reference. One or more first guide rails 106 disposed in the front-rear direction are provided on the center housing 102. The center lamp housing 104 is mounted to be movable along the first guide rails 106 in the front-rear direction. The center lamp housing 104 may have a shape that covers an upper surface of the center housing 102.

The center rear lamp 200 is mounted on a rear surface of the center lamp housing 104. The center rear lamp 200 is a part responsible for lighting the rear portion 10 of the vehicle with the side rear lamps 210. In addition, a mounting bracket 114 for mounting the first sliding part 120 and an interlocking part 130 are installed in the center housing 102. The mounting bracket 114 is installed in the center housing 102, and a first driving shaft 112 passes through the mounting bracket 114. The first sliding part 120 and the interlocking part 130 may be mounted on the first driving shaft 112 passing through the mounting bracket 114.

The first sliding part 120 may include a first crankshaft 122 rotatably mounted on the first driving shaft 112 and may include a first rod 124 of which a rear end is rotatably connected to the first crankshaft 122 and of which a front end is rotatably connected to the center lamp housing 104.

The first crankshaft 122 is a part that is mounted on the first driving shaft 112 and rotated by rotation of the first driving shaft 112. The first rod 124 is a part rotatably connected to the first crankshaft 122. The front end of the first rod 124 is rotatably connected to the center lamp housing 104. Accordingly, when the first driving shaft 112 is rotated by driving of the first actuator 110, the first crankshaft 122 and the first rod 124 are unfolded rearward and rotated. When the first crankshaft 122 and the first rod 124 are rotated to a rearmost side, the first rod 124 may be fixed.

A hooking protrusion 126 may be provided on an outer surface of the first crankshaft 122 and on which a hooking end 133 formed on an interlocking cam 132, which is described below, is hooked when the spoiler 300 is tilted at a maximum angle.

The interlocking part 130 may be rotated according to driving of the first actuator 110. When the center lamp housing 104 moves rearward, the interlocking part 130 may be rotated with the spoiler driver 140 and hooked on the first sliding part 120. The interlocking part 130 is a part that operates in conjunction with driving of the first sliding part 120. When the first sliding part 120 moves the center lamp housing 104 to the rearmost side, the interlocking part 130 serves to lock the first sliding part 120. When the interlocking part 130 locks the first sliding part 120, the first sliding part 120 does not move the center lamp housing 104 any further rearward and tilts the spoiler 300 in conjunction with the spoiler driver 140.

The interlocking part 130 may include the interlocking cam 132 rotatably mounted on the first driving shaft 112 and may include an interlocking member 134, which is inserted into a first guide slot 160 formed to be curved in the center lamp housing 104 and moved according to rotation of the interlocking cam 132 therewith.

The interlocking cam 132 may be formed in a cam shape and rotated according to rotation of the first driving shaft 112. The hooking end 133, which is hooked on the hooking protrusion 126 provided on the first crankshaft 122, is provided on the interlocking cam 132. The hooking end 133 is hooked on the hooking protrusion 126 and locked when the spoiler 300 is tilted at the maximum angle.

The first guide slot 160 may be formed in an up-standing surface of the center lamp housing 104. A first guide pin 136, inserted into the first guide slot 160, may be provided on the interlocking member 134. The first guide slot 160 may be formed in a circumferential shape with a predetermined central angle.

The spoiler driver 140 may include a second crankshaft 142 rotatably mounted on the first driving shaft 112 and may include a second rod 144, which has a rear end rotatably connected to the second crankshaft 142 and a front end rotatably connected to a guide part 150 provided on the center lamp housing 104. A second guide pin 146, inserted into and guided by a second guide slot 172, is provided on the front end of the second rod 144.

A pair of guide members 170, disposed in parallel, may be mounted on the center lamp housing 104. The second guide slot 172 may be formed in each of the guide members 170 in the front-rear direction. The guide part 150 may be mounted between the guide members 170 to be movable in the front-rear direction. A structure of the guide part 150 is described below in detail with reference to the drawings.

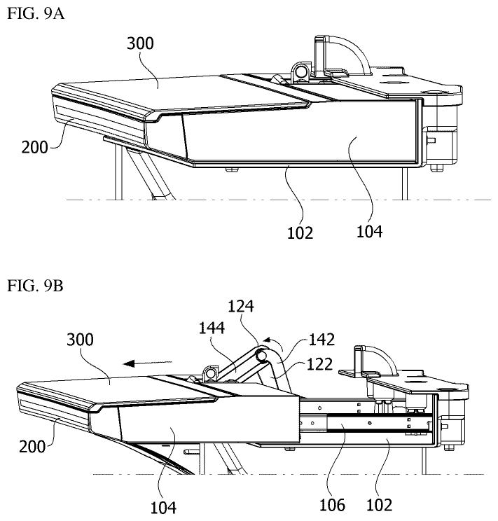

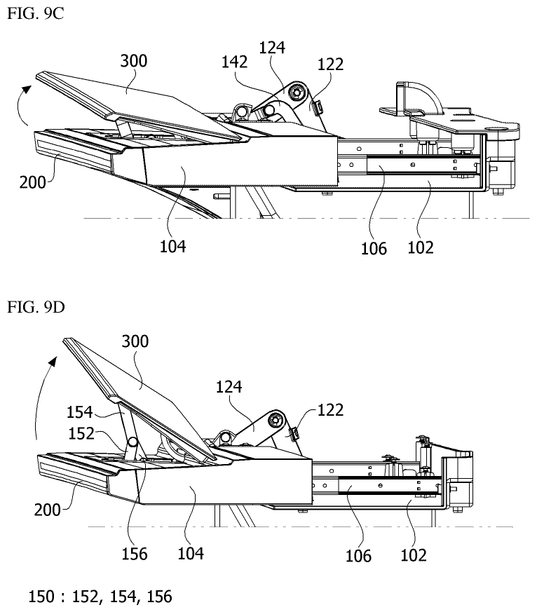

Referring to FIGS. 9D, 10C, 11C, and 12D, the guide part 150 may include a first link 152, both sides of which are inserted into the second guide slots 172 and to which the second rod 144 is rotatably connected. The guide part 150 may also include a second link 154 rotatably connected to a front end of the first link 152 and rotatably connected to a lower surface of the spoiler 300.

Both sides of the guide part 150 may be inserted into the second guide slots 172 and guided in the front-rear direction. A rear end of the first link 152 of the guide part 150 is rotatably connected to the second rod 144. Accordingly, when the spoiler driver 140 moves rearward, the second crankshaft 142 and the second rod 144 may be unfolded rearward and rotated, and the first link 152 may be moved rearward and rotated in conjunction therewith. The second link 154 may be unfolded rearward and rotated in conjunction with the rotation of the first link 152.

A third link 156 may be rotatably connected to one side of the guide member 170. The third link 156 is rotatably connected to the first link 152 to serve to support the first link 152. To this end, one end of the third link 156 may be rotatably connected to the guide member 170, and the other end may be rotatably connected to the first link 152.

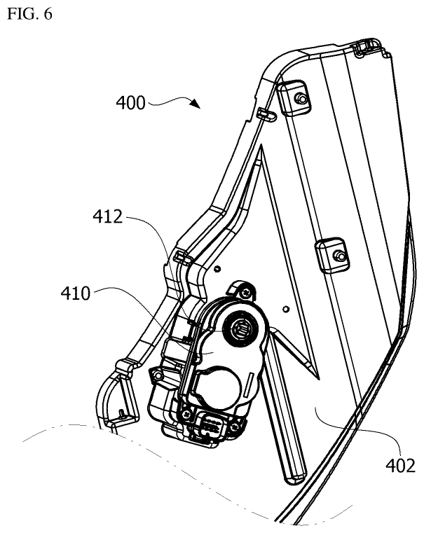

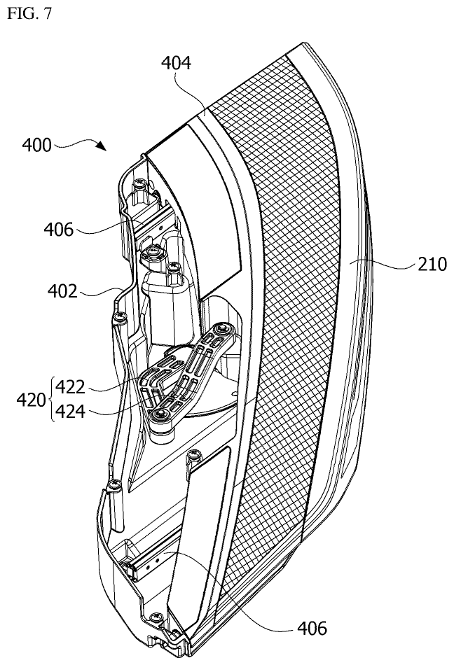

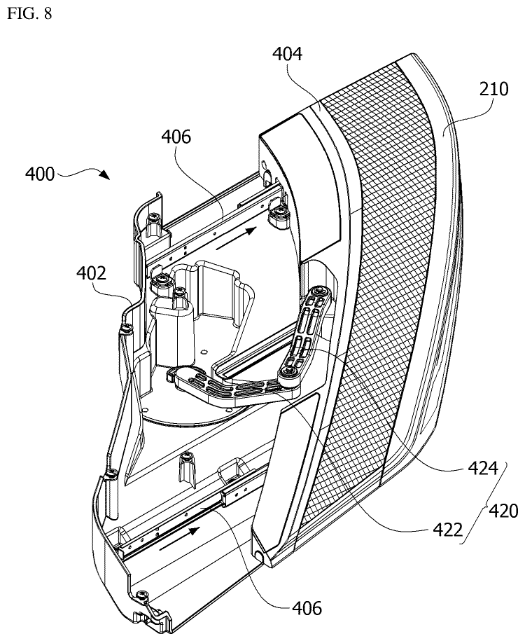

FIG. 6 is a view illustrating a lower surface of the side driver according to one embodiment of the present disclosure. FIG. 7 is a view illustrating a state in which the side driver is not yet operated according to one embodiment of the present disclosure. FIG. 8 is a view illustrating a state in which the side rear lamp has moved rearward in the side driver according to one embodiment of the present disclosure.

Referring to FIGS. 6-8, each of the side drivers 400 may include: a side housing 402; a second lamp housing 404, which is mounted on the side housing 402 to be movable rearward and on which one of the side rear lamps 210 is mounted; a second actuator 410 provided on the side housing 402; a second driving shaft 412, which is rotated according to driving of the second actuator 410; and a second sliding part 420, which is rotatably mounted on the second driving shaft 412 and moves the second lamp housing 404.

A pair of side housings 402 may be disposed respectively at both sides of the center housing 102. The second lamp housing 404 is mounted on the side housing 402 to be movable in the front-rear direction. One or more second guide rails 406 disposed in the front-rear direction are provided on the side housing 402. The second lamp housing 404 is mounted to be movable along the second guide rails 406 in the front-rear direction. The second lamp housing 404 may have a shape that covers the upper surface of the center housing 102.

The side rear lamp 210 is mounted on a rear surface of the second lamp housing 404. The side rear lamp 210 is a part responsible for lighting the rear portion 10 of the vehicle with the center rear lamp 200.

The second sliding part 420 may include a second crankshaft 422 rotatably mounted on the second driving shaft 412 and may include a third rod 424, which has a rear end rotatably connected to the second crankshaft 422 and a front end rotatably connected to the second lamp housing 404.

The second crankshaft 422 is a part mounted on the second driving shaft 412 and rotated by rotation of the second driving shaft 412. The third rod 424 is a part rotatably connected to the second crankshaft 422. The front end of the third rod 424 is rotatably connected to the second lamp housing 404. Accordingly, when the second driving shaft 412 is rotated by driving of the second actuator 410, the second crankshaft 422 and the third rod 424 are unfolded rearward and rotated. When the second crankshaft 422 and the third rod 424 are rotated to a rearmost side, the third rod 424 may be fixed to the second lamp housing 404.

Hereinafter, an operation process of the center driver of the variable spoiler lighting apparatus of a vehicle having the above-described structure according to the present disclosure is described in detail. For the sake of convenience, the operation of the center driver 100 is described with reference to the accompanying drawings illustrated for each component.

The variable spoiler lighting apparatus of a vehicle according to the present disclosure may mainly operate in three modes (the first mode, the second mode, and the third mode), and the third mode in which the spoiler 300 is tilted may include a 3-1 mode and a 3-2 mode according to a tilting angle. Hereinafter, each main mode is described.

FIG. 9A is a view illustrating a state in which the center driver is not operated yet according to one embodiment of the present disclosure, and FIG. 9B is a view illustrating a state in which the center rear lamp has moved rearward in the center driver according to one embodiment of the present disclosure. FIG. 9C is a view illustrating a state in which the spoiler is tilted at a first angle in the center driver according to one embodiment of the present disclosure, and FIG. 9D is a view illustrating a state in which the spoiler is tilted at a second angle in the center driver according to one embodiment of the present disclosure.

FIG. 9A illustrates a state in the first mode, FIG. 9B illustrates a state in the second mode, FIG. 9C illustrates a state in the third 3-1 mode, and the FIG. 9D illustrates a state in the third 3-2 mode.

Referring to FIG. 9A, in the first mode, the center lamp housing 104 is positioned coplanar with an outer surface of the rear portion 10 of the vehicle. In other words, the center lamp housing 104 is moved to a foremost side or position on the center housing 102, retracted into the rear portion of the vehicle, and not exposed to the outside. In addition, the spoiler 300 is folded and positioned inside the rear portion 10 of the vehicle.

Referring to FIG. 9B, in the second mode, the first actuator 110 is driven, and the first driving shaft 112 is rotated by the driving of the first actuator 110. The first crankshaft 122 is rotated by the rotation of the first driving shaft 112, and the first rod 124 is unfolded and rotated in conjunction therewith. In this process, the center lamp housing 104 moves rearward along the first guide rail 106. Meanwhile, in the second mode, the second lamp housing 404 also moves rearward along the second guide rail 406.

Meanwhile, in the second mode, the spoiler 300 remains folded without being tilted and the center lamp housing 104 and the second lamp housing 404 are moved rearward and exposed to the outside of the rear portion 10. Thus, the center rear lamp 200 and the side rear lamp 210 may be exposed to the outside. Also, a vortex generated at the rear of the vehicle may be eliminated by the center lamp housing 104 and the second lamp housing 404 to increase a distance to empty of the vehicle.

Referring to FIG. 9C, in the 3-1 mode, in a state in which the second lamp housing 404 is moved rearward, the guide part 150 may be driven by driving of the spoiler driver 140. When the spoiler driver 140 moves rearward, the second crankshaft 142 and the second rod 144 may be unfolded rearward and rotated, and the first link 152 may be moved rearward and rotated in conjunction therewith. The second link 154 may be unfolded rearward and rotated in conjunction with the rotation of the first link 152.

When the guide part 150 is driven as described above, the spoiler 300 may rotate upward at the first angle. For example, the spoiler 300 may rotate upward 11°.

Referring to FIG. 9D, in the 3-2 mode, the spoiler 300 may be rotated upward at the second angle by the driving of the guide part 150. For example, the spoiler 300 may rotate upward 36°. As one embodiment, the 3-2 mode may be applied to higher speed driving than the 3-1 mode.

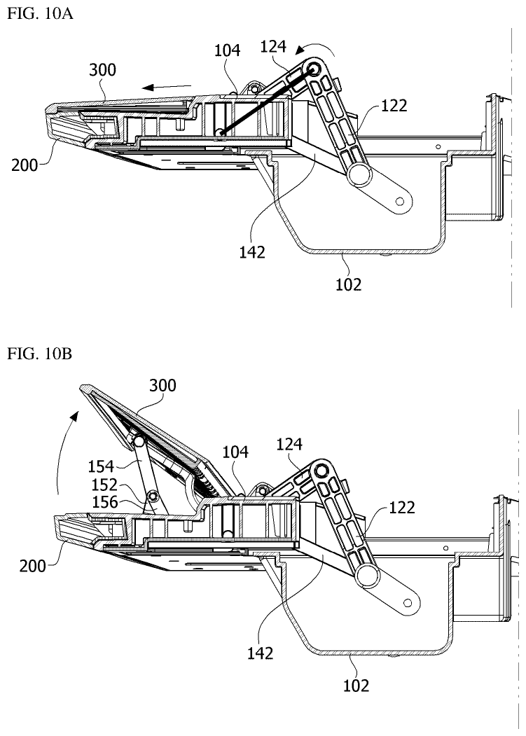

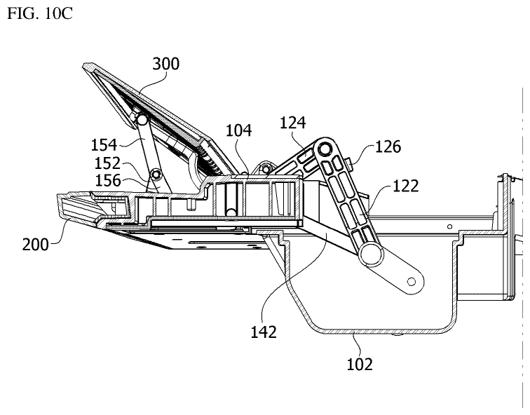

FIG. 10A is a view illustrating a first sliding part in the state in which the center driver is not yet operated according to one embodiment of the present disclosure. FIG. 10B is a view illustrating the first sliding part in the state in which the center rear lamp has moved rearward in the center driver according to one embodiment of the present disclosure. FIG. 10C is a view illustrating the first sliding part in the state in which the spoiler is tilted at the second angle in the center driver according to one embodiment of the present disclosure.

FIG. 10A illustrates the state in the first mode, FIG. 10B illustrates the state in the second mode, and FIG. 10C illustrates a state in the third mode.

Referring to FIG. 10A, in the first mode, the first sliding part 120 maintains a state in which the first crankshaft 122 and the first rod 124 are folded rearward.

Referring to FIG. 10B, in the second mode, the first actuator 110 is driven, and the first driving shaft 112 is rotated by the driving of the first actuator 110. The first crankshaft 122 is rotated by the rotation of the first driving shaft 112, and the first rod 124 is unfolded and rotated in conjunction therewith. In this process, the center lamp housing 104 moves rearward along the first guide rail 106. Meanwhile, in the second mode, the second lamp housing 404 also moves rearward along the second guide rail 406.

Referring to FIG. 10C, in the 3-1 mode and 3-2 mode, the first sliding part 120 is not driven. When the first sliding part 120 is driven in the second mode, the first sliding part 120 is moved to the rearmost side and locked to the center lamp housing 104.

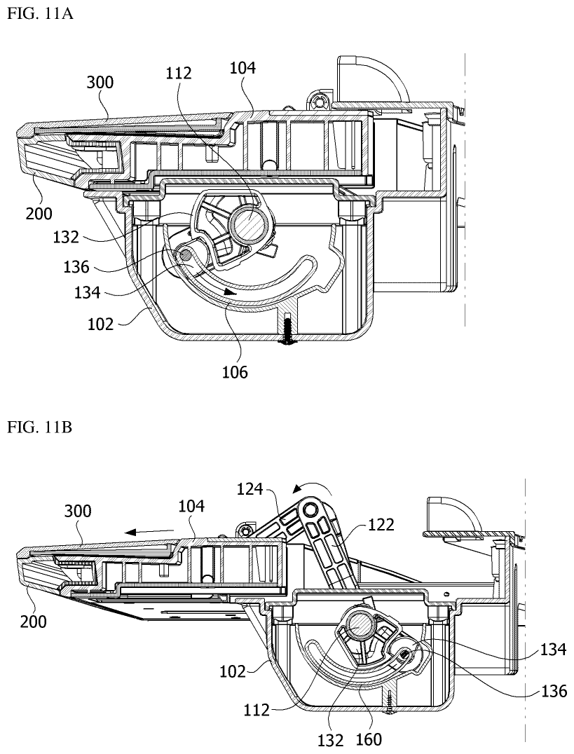

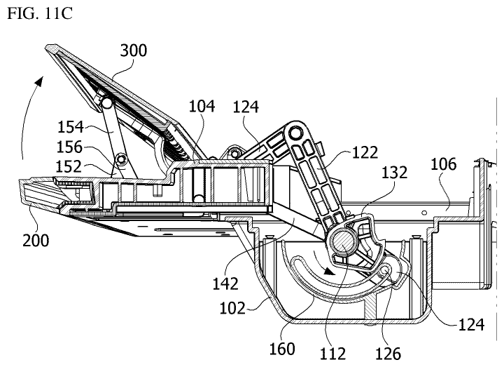

FIG. 11A is a view illustrating the interlocking part in the state in which the center driver is not yet operated according to one embodiment of the present disclosure. FIG. 11B is a view illustrating the interlocking part in the state in which the center rear lamp has moved rearward in the center driver according to one embodiment of the present disclosure. FIG. 11C is a view illustrating the interlocking part in the state in which the spoiler is tilted at the second angle in the center driver according to one embodiment of the present disclosure.

FIG. 11A illustrates the state in the first mode, FIG. 11B illustrates the state in the second mode, and FIG. 11C illustrates the state in the third mode.

Referring to FIG. 11A, in the first mode, the interlocking part 130 is positioned behind the center lamp housing 104.

Referring to FIG. 11B, in the second mode, when the first actuator 110 is driven, the first sliding part 120 may be moved rearward, and the interlocking part 130 may be rotated in conjunction therewith. In the interlocking part 130, the interlocking member 134 may be rotated forward by the first guide pin 136 inserted into the first guide slot 160. In this case, the interlocking cam 132 and the interlocking member 134 may be rotated from a rear side to a foremost side.

Referring to FIG. 11C, in the 3-1 mode and 3-2 mode, the first sliding part 120 may not be driven, and the interlocking part 130 may be continuously rotated. In this process, the interlocking cam 132 rotates to rotate and lock the interlocking member 134. The interlocking cam 132 is locked to the first crankshaft 122 at a position at which the spoiler 300 is completely tilted. In this case, the locking of the interlocking cam 132 and the first crankshaft 122 is performed by the hooking end 133 being hooked on the hooking protrusion 126.

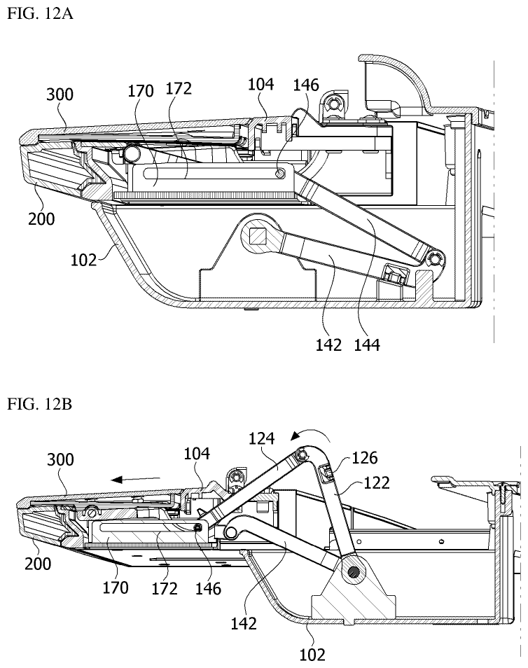

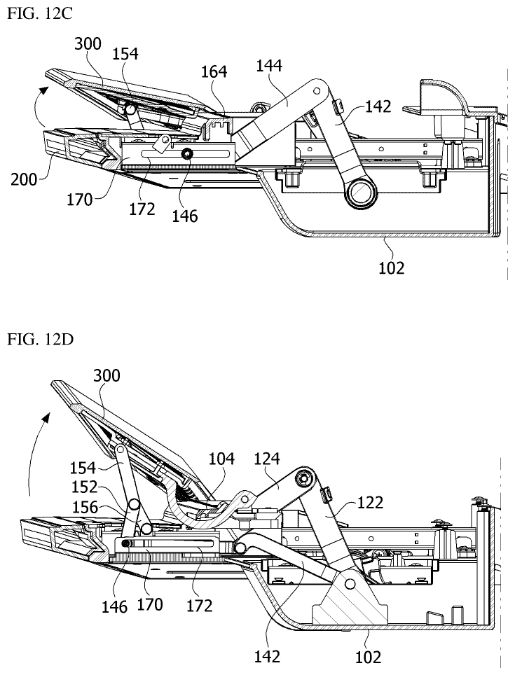

FIG. 12A is a view illustrating the spoiler driver in the state in which the center driver is not yet operated according to one embodiment of the present disclosure. FIG. 12B is a view illustrating the spoiler driver in the state in which the center rear lamp has moved rearward in the center driver according to one embodiment of the present disclosure. FIG. 12C is a view illustrating the spoiler driver in the state in which the spoiler is tilted at the first angle in the center driver according to one embodiment of the present disclosure. FIG. 12D is a view illustrating the spoiler driver in the state in which the spoiler is tilted at the second angle in the center driver according to one embodiment of the present disclosure.

FIG. 12A illustrates the state in the first mode, FIG. 12B illustrates the state in the second mode, FIG. 12C is the state in the third 3-1 mode, and FIG. 12D is the state in the third 3-2 mode.

Referring to FIG. 12A, in the first mode, the second crankshaft 142 and the second rod 144 constituting the spoiler driver 140 remain folded rearward. In addition, the first link 152 and the second link 154 constituting the guide part 150 remain folded rearward.

Referring to FIG. 12B, in the second mode, the first sliding part 120 may move rearward as described above. In this case, since a portion of the front end of the first rod 124 of the first sliding part 120 connected to the center lamp housing 104 is not changed, the spoiler driver 140 and the guide part 150 are not driven.

Referring to FIG. 12C, in the 3-1 mode, the spoiler driver 140 is rotated as the second crankshaft 142 and the second rod 144 are unfolded rearward. In addition, the second rod 144 moves rearward to move the first link 152 of the guide part 150 rearward, and the first link 152 and the second link 154 are unfolded rearward and rotated. The first link 152 may move along the second guide slot 172 of the guide member 170. In this case, the spoiler 300 may be tilted upward at the first angle in conjunction with the rotation of the second link 154.

Referring to FIG. 12D, in the 3-2 mode, when the first link 152 and the second link 154 of the guide part 150 are maximally rotated, the spoiler 300 may be tilted at the second angle and locked.

According to one embodiment of the present disclosure, a rear lamp protruding rearward according to a mode can serve a lighting function and eliminate a vortex generated at the rear of a vehicle to increase a distance to empty of the vehicle.

In addition, according to one embodiment of the present disclosure, a spoiler can serve an assistance function in safe driving by inducing a downward stance or pose during high speed driving or rough weather when the spoiler is tilted while protruding rearward according to a mode and can improve a contact force between a vehicle and a road surface and suppress generation of a left-right rolling phenomenon even during the high speed driving.

While the present disclosure has been described above with reference to example embodiments, it may be understood by those of ordinary skill in the art that various modifications and changes of the present disclosure may be made within a range not departing from the spirit and scope of the present disclosure defined by the appended claims.

What is claimed is:

1. A variable spoiler lighting apparatus of a vehicle, comprising:
a center driver, which is configured to be provided on a central portion of a rear portion of a vehicle and to be movable rearward and forward relative to a rear portion of a vehicle;
a spoiler mounted on the center driver and tiltable according to a driving mode;
a center rear lamp mounted on the center driver;
a first side driver, which is disposed at a first side of the center driver and configured to be movable forward and rearward relative to the rear portion of a vehicle; and
a first side rear lamp mounted on the side driver.

2. The variable spoiler lighting apparatus of claim 1, wherein the center driver comprises:
a center housing;
a center lamp housing mounted on the center housing and configured to be movable forward and rearward and on which the center rear lamp and the spoiler are mounted;
a first actuator provided on the center housing;
a first driving shaft rotatable according to driving of the first actuator;
a first sliding part rotatably mounted on the first driving shaft and configured to move the center lamp housing; and
a spoiler driver rotatably mounted on the first driving shaft and configured to tilt the spoiler according to the driving mode in a state in which the center lamp housing has moved rearward.

3. The variable spoiler lighting apparatus of claim 2, wherein the first sliding part comprises:
a first crankshaft rotatably mounted on the first driving shaft; and
a first rod having a rear end rotatably connected to the first crankshaft and a front end rotatably connected to the center lamp housing.

4. The variable spoiler lighting apparatus of claim 3, further comprising an interlocking part configured to rotate according to the driving of the first actuator, and, when the center lamp housing moves rearward, to rotate with the spoiler driver and hook on the first sliding part.

5. The variable spoiler lighting apparatus of claim 4, wherein the interlocking part comprises:
an interlocking cam rotatably mounted on the first driving shaft; and
an interlocking member inserted into a curved first guide slot in the center lamp housing and configured to move with the interlocking cam when rotated.

6. The variable spoiler lighting apparatus of claim 5, wherein a hooking protrusion is provided on an outer surface of the first crankshaft, and wherein a hooking end in the interlocking cam is hooked on the hooking protrusion when the spoiler is tilted at a maximum angle.

7. The variable spoiler lighting apparatus of claim 2, wherein the spoiler driver comprises:
a second crankshaft rotatably mounted on the first driving shaft; and
a second rod having a rear end rotatably connected to the second crankshaft and a front end rotatably connected to a guide part provided on the center lamp housing.

8. The variable spoiler lighting apparatus of claim 7, wherein:
a pair of guide members disposed in parallel are mounted on the center lamp housing;
second guide slots are respectively provided in the pair of guide members in a front-rear direction; and
the guide part is disposed between the pair of guide members and is configured to be movable in the front-rear direction.

9. The variable spoiler lighting apparatus of claim 8, wherein the guide part comprises:
a first link with portions inserted into the second guide slots and to which the second rod is rotatably connected; and
a second link rotatably connected to a front end of the first link and rotatably connected to a lower surface of the spoiler.

10. The variable spoiler lighting apparatus of claim 9, wherein a rear end of the first link is rotatably connected to the second rod.

11. The variable spoiler lighting apparatus of claim 9, further comprising a third link rotatably connected to one side of the pair of guide members, rotatably connected to the first link, and supporting the first link.

12. The variable spoiler lighting apparatus of claim 2, wherein:
one or more first guide rails are provided on the center housing; and
the center lamp housing movable along the first guide rails in a front-rear direction.

13. The variable spoiler lighting apparatus of claim 1, wherein the first side driver comprises:
a first side housing;
a first side lamp housing mounted on the first side housing and configured to be movable forward and rearward and on which the first side rear lamp is mounted;
a second actuator provided on the first side housing;
a second driving shaft configured to rotate according to driving of the second actuator; and
a second sliding part rotatably mounted on the second driving shaft and configured to move the first side lamp housing.

14. The variable spoiler lighting apparatus of claim 13, wherein the second sliding part comprises:
a third crankshaft rotatably mounted on the second driving shaft; and
a third rod having a rear end rotatably connected to the third crankshaft and a front end rotatably connected to the second lamp housing.

15. The variable spoiler lighting apparatus of claim 13, wherein:
one or more second guide rails are provided on the first side housing; and
the first side lamp housing is movable along the second guide rails in a front-rear direction.

16. The variable spoiler lighting apparatus of claim 1, further comprising:
a second side driver disposed on a second side of the center driver opposite the first side; and
a second side rear lamp mounted on the second side driver.

17. A vehicle comprising:
a rear portion at a rear end of the vehicle; and
a variable spoiler lighting apparatus movable between a retracted state and a rearward deployed state relative to the rear portion of the vehicle, the variable spoiler lighting apparatus including
a center driver on a central portion of the rear portion of the vehicle and configured to be movable rearward and forward relative to the rear portion,
a spoiler mounted on the center driver and tiltable according to a driving mode,
a center rear lamp mounted on the center driver,
a first side driver disposed at a first side of the center driver and configured to be movable forward and rearward relative to the rear portion of the vehicle, and
a first side rear lamp mounted on the side driver.
